(19) United States
(12) Patent Application Publication
(10) Pub. No.: US 2017/0303001 A1
(43) Pub. Date: Oct. 19, 2017

(54) SYSTEMS AND METHODS FOR OPTIMIZING CONTENT CREATION ON A MOBILE PLATFORM USING MOBILE MULTI-TRACK TIMELINE-OPTIMIZED EDITING AND VIEWER INTEREST CONTENT FOR VIDEO

(71) Applicant: Koowalla Inc., Los Angeles, CA (US)

(72) Inventors: Ethan Montoya, Los Angeles, CA (US); Bryan Cattle, Los Angeles, CA (US)

(21) Appl. No.: 15/491,940

(22) Filed: Apr. 19, 2017

Related U.S. Application Data
(60) Provisional application No. 62/324,847, filed on Apr. 19, 2016.

(51) Int. Cl. H04N 21/466; H04N 21/472; H04M 1/725; G11B 27/031; G11B 27/00; H04N 21/4788; G06F 3/0488

(52) U.S. Cl. CPC H04N 21/4667; H04N 21/4788; H04N 21/47205; G06F 3/0488; G11B 27/031; G11B 27/002; H04M 1/72522

(57) ABSTRACT

An embedded editing system allows mobile video capture, editing, and sharing/publishing. The systems and methods disclosed herein may facilitate mobile multi-track timeline-based video editing. The systems and methods disclosed herein may allow for easy creation of picture-in-picture videos and/or other forms of video and/or other forms of creative or expressive content, particularly content captured from mobile devices. Feedback interactions captured at a viewer device may be used as the basis of viewer interest content provided to a user capturing and publishing video content and/or to third parties. The feedback interactions may visually represent content-level feedback against interactive portions of video content.

### CLAIM OF PRIORITY

The present application claims priority under 35 U.S.C. §119 to Provisional U.S. Patent Application Ser. No. 62/324,847, filed Apr. 19, 2016, entitled, “Systems and Methods for Optimizing Content Creation on a Mobile Platform Using Mobile Multi-Timeline-Optimized Editing,” to inventors Ethan Montoya et al. The contents of Provisional U.S. Patent Application Ser. No. 62/324,847 are hereby incorporated by reference as if set forth fully herein.

### TECHNICAL FIELD

The technical field relates to content creation and editing on mobile devices and/or platforms, and more particularly to content creation and editing techniques optimized for mobile devices and/or platforms.

### BACKGROUND

Mobile devices often allow people to capture video or access stored videos. Though many mobile devices provide video editing capabilities, video editing applications are often not optimized for mobile platforms. Mobile publishing platforms typically lack an embedded, sophisticated video editor. Users of these platforms are typically forced to either cope with poor quality or to go to laptops, desktops, etc. to edit and publish videos. Additionally, many standalone video editing applications were not made to fit within the natural creative processes of video editors. Video logging (“vlogging”) and/or voiceover narration are often implemented awkwardly or inefficiently on mobile platforms. It would be desirable to optimize video editing for mobile platforms. Doing so may help users share and/or publish creative content generated on mobile devices with friends, social connections, and/or the general public. The introduction of advanced video editing tools for mobile will lead to the creation of longer user-generated videos. Watching longer user-generated videos on their phones represents a behavioral change for viewers, and it will create the need for additional viewer interest content to keep them engaged.

### SUMMARY

An embedded editing system allows mobile video capture, editing, and sharing/publishing. The systems and methods disclosed herein may facilitate mobile multi-track timeline video editing. The systems and methods disclosed herein may allow for easy creation of picture-in-picture videos and/or other forms of video and/or other forms of creative or expressive content, particularly content captured from mobile devices. Additionally, video logging (“vlogging”) in public is highly awkward for many people. In various implementations, a multiple-timeline editing system enables video creators to add narration after they have filmed a video, which avoids the need to narrate vlogs in public. Additionally, vlogging in public previously led to poor audio quality due to environmental and other sources of noise. In some implementations, a multiple-timeline editing system enables creators to control the volume of their narration. Voiceover narration, previously the only solution for adding voice narration on a mobile device, is a technically inferior solution to various implementations, which allow for multi-track timeline video editing because voiceover narration requires exact timing alignment and it does not enable the display of users' faces in video. The systems and methods discussed herein provide technical solutions of allowing people to interact with digital video; feedback interactions captured at a viewer device may be used as the basis of viewer interest content provided to a user capturing and publishing video content and/or to third parties. The feedback interactions may visually represent content-level feedback against interactive portions of video content.

A technical problem was that these functions were previously not possible on mobile platforms. A technical solution includes creating various functionalities to be available on a mobile platform. Additional technical solutions relate to the ability to proliferate video editing capabilities on mobile platforms.

These and other advantages will become apparent to those skilled in the relevant art upon a reading of the following descriptions and a study of the several examples of the drawings.

### BRIEF DESCRIPTION OF THE DRAWINGS

FIG. 1 shows an example of a mobile multi-track timeline optimized editing system, according to some implementations.

FIG. 2 shows an example of a flowchart of a method for accessing mobile multi-track timeline optimized editing processes on a mobile device, according to some implementations.

FIG. 3 shows an example of a flowchart of a method for performing a single-track editing process on a mobile device, according to some implementations.

FIG. 4 shows an example of a flowchart of a method for performing a multi-track editing process on a mobile device, according to some implementations.

FIG. 5 shows an example of a flowchart of a method for performing voiceover recording over a video on a mobile device, according to some implementations.

FIG. 6 shows an example of a flowchart of a method for sharing/publishing content created on a mobile device, according to some implementations.

FIG. 7 shows an example of screen captures taken on a mobile device having an application implementing mobile multi-track timeline optimized editing processes, according to some implementations.

FIG. 8A shows an example of screen captures taken on a mobile device having an application implementing mobile multi-track timeline optimized editing processes, according to some implementations.

FIG. 8B shows an example of screen captures taken on a mobile device having an application implementing mobile multi-track timeline optimized editing processes, according to some implementations.

FIG. 9 shows an example of screen captures taken on a mobile device having an application implementing mobile multi-track timeline optimized editing processes, according to some implementations.

FIG. 10 shows an example of a computer system, according to some implementations.

FIG. 11 shows an example of a screen capture taken on a mobile device having an application implementing touch feedback design, according to some implementations.

FIG. 12 shows an example of a flowchart of a method for performing a touch feedback video editing process on a mobile device, according to some implementations.

FIG. 13 shows an example of a flowchart of a method for performing a re-editable mobile video system process on a mobile device, according to some implementations.

FIG. 14 shows an example of a flowchart of a method for performing a proxy editing process on a mobile device, according to some implementations.

FIG. 15 shows an example of a flowchart of a method for displaying viewer interest content for video content, according to some implementations.

### DETAILED DESCRIPTION

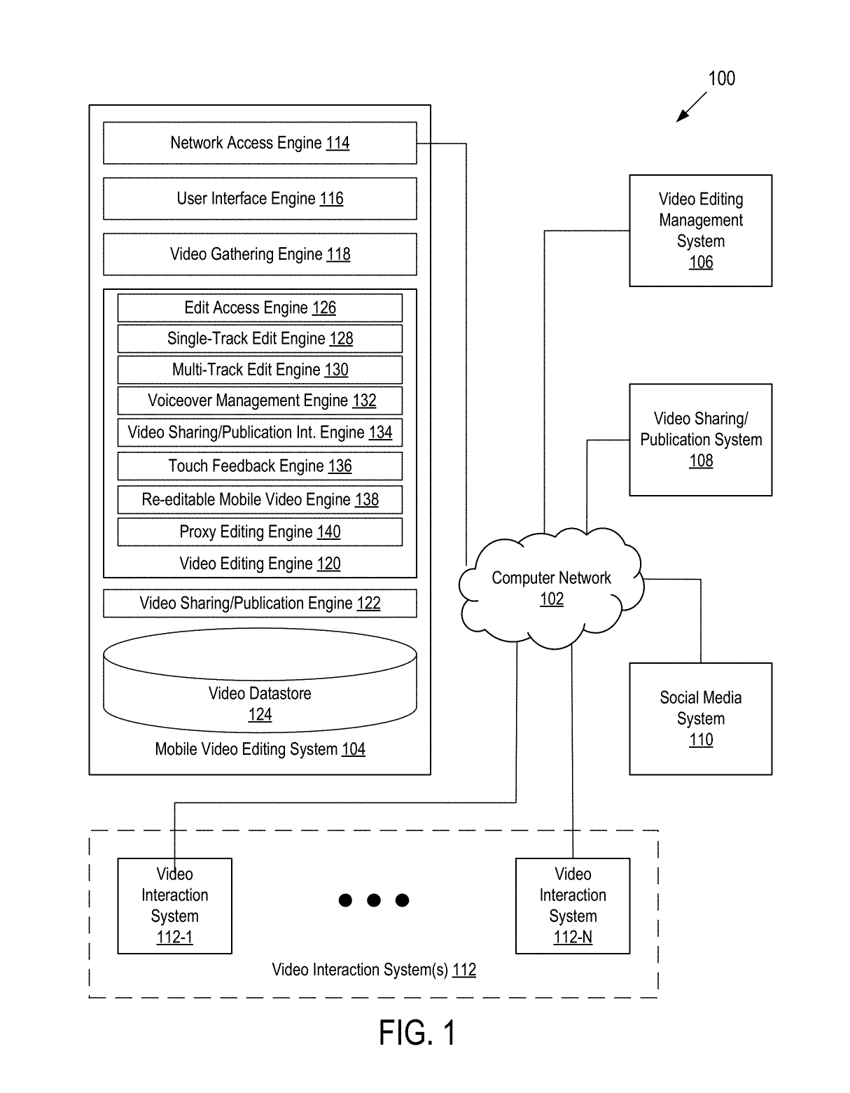

FIG. 1 shows an example of a mobile multi-track timeline optimized editing system 100, according to some implementations. The mobile multi-track timeline optimized editing system 100 may include a computer network 102, a mobile video editing system 104, a video editing management system 106, a video sharing/publication system 108, a social media system 110, and video interaction system(s) 112. In the example of FIG. 1, the computer network 102 is shown coupled to the mobile video editing system 104, the video editing management system 106, the video sharing/publication system 108, the social media system 110, and the video interaction system(s) 112. It is noted that this coupling, and any coupling referenced herein is shown by way of example only, and that various implementations may include more, less, or different couplings than explicitly shown.

The computer network 102 and other computer readable mediums discussed in this paper are intended to represent a variety of potentially applicable technologies. For example, the computer network 102 can be used to form a network or part of a network. Where two components are co-located on a device, the computer network 102 can include a bus or other data conduit or plane. Where a first component is co-located on one device and a second component is located on a different device, the computer network 102 can include a wireless or wired back-end network or LAN. The computer network 102 can also encompass a relevant portion of a WAN or other network, if applicable.

The computer network 102, the mobile video editing system 104, the video editing management system 106, the video sharing/publication system 108, social media system 110, and the video interaction system(s) 112, and other applicable systems or devices described in this paper can be implemented as a computer system or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The mobile video editing system 104 may include any digital device. In some implementations, the mobile video editing system 104 may comprise a mobile phone, a tablet computing device, or an Internet of Things (IoT) device. In an implementation, the mobile video editing system 104 is configured to implement mobile multi-track timeline optimized editing processes. The mobile video editing system 104 may include a network access engine 114, a user interface engine 116, a video gathering engine 118, a video editing engine 120, a video sharing/publication engine 122, and a video datastore 124.

The network access engine 114 may facilitate access to the computer network 102. The user interface engine 116 may support a user interface for a user of the mobile video editing system 104. The video gathering engine 118 may facilitate gathering captured or stored video (e.g., live captured video captured from a camera of the mobile video editing system 104 or stored video stored on storage of the mobile video editing system 104).

The video editing engine 120 may support a video editing application on the mobile video editing system 104. In an implementation, the video editing application comprises a mobile application. The video editing application may comprise an embedded application. The video editing engine 120 may include an edit access engine 126, a single-track edit engine 128, a multi-track edit engine 130, a voiceover management engine 132, a video sharing/publication interface engine 134, a touch feedback engine 136, a re-editable mobile video engine 138, and a proxy editing engine 140.

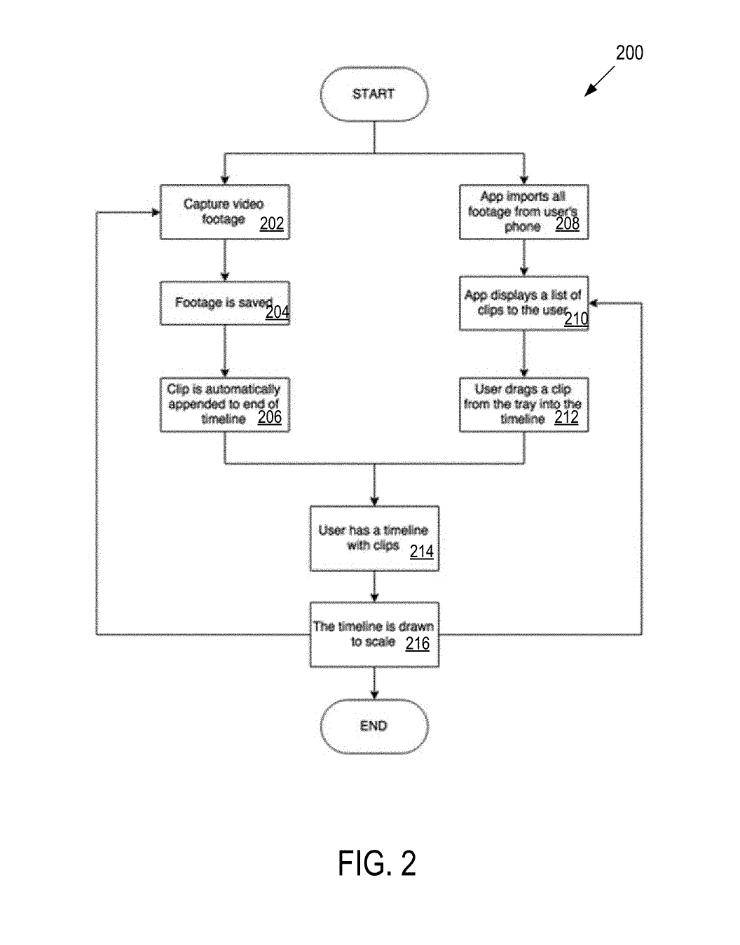

The edit access engine 126 may allow access to editing. In an implementation, the edit access engine 126 may access one or more processors of the mobile video editing system 104 and may access memory on the mobile video editing system 104 configured to instruct the one or more processors to perform the computer-implemented shown in FIG. 2.

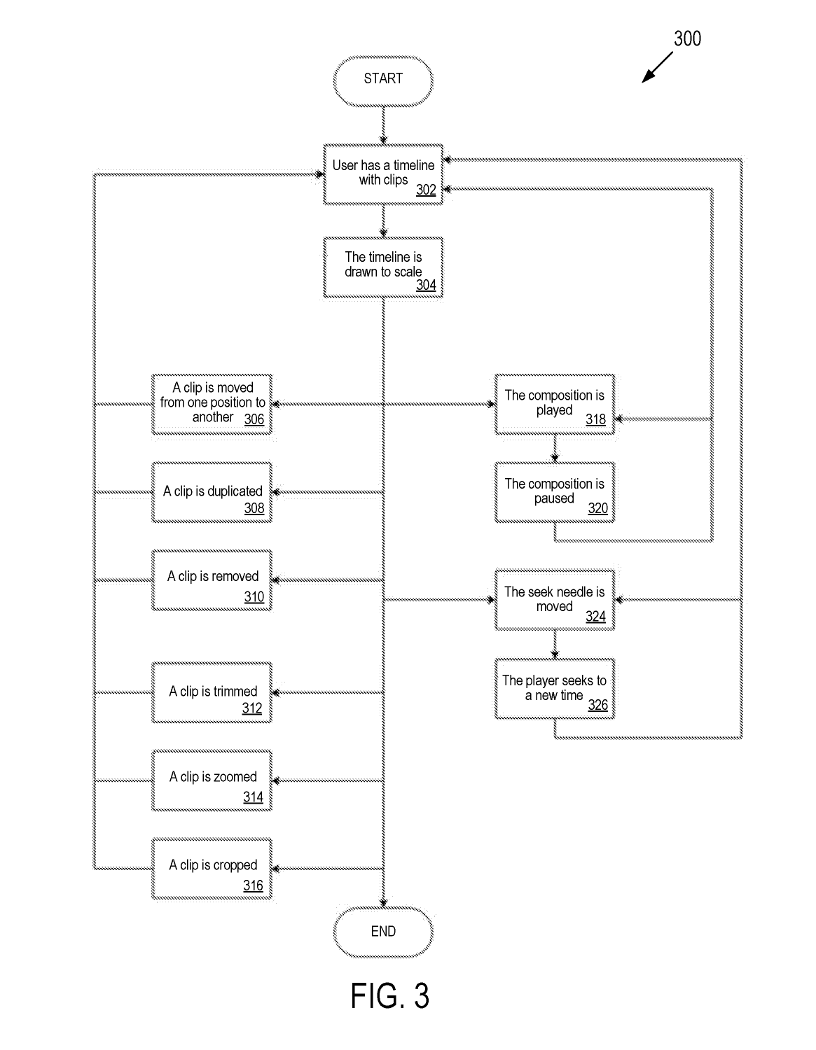

The single-track edit engine 128 may facilitate single-track editing processes. In an implementation, the single-track edit engine 128 may access one or more processors of the mobile video editing system 104 and may access memory on the mobile video editing system 104 configured to instruct the one or more processors to perform the computer-implemented method shown in FIG. 3.

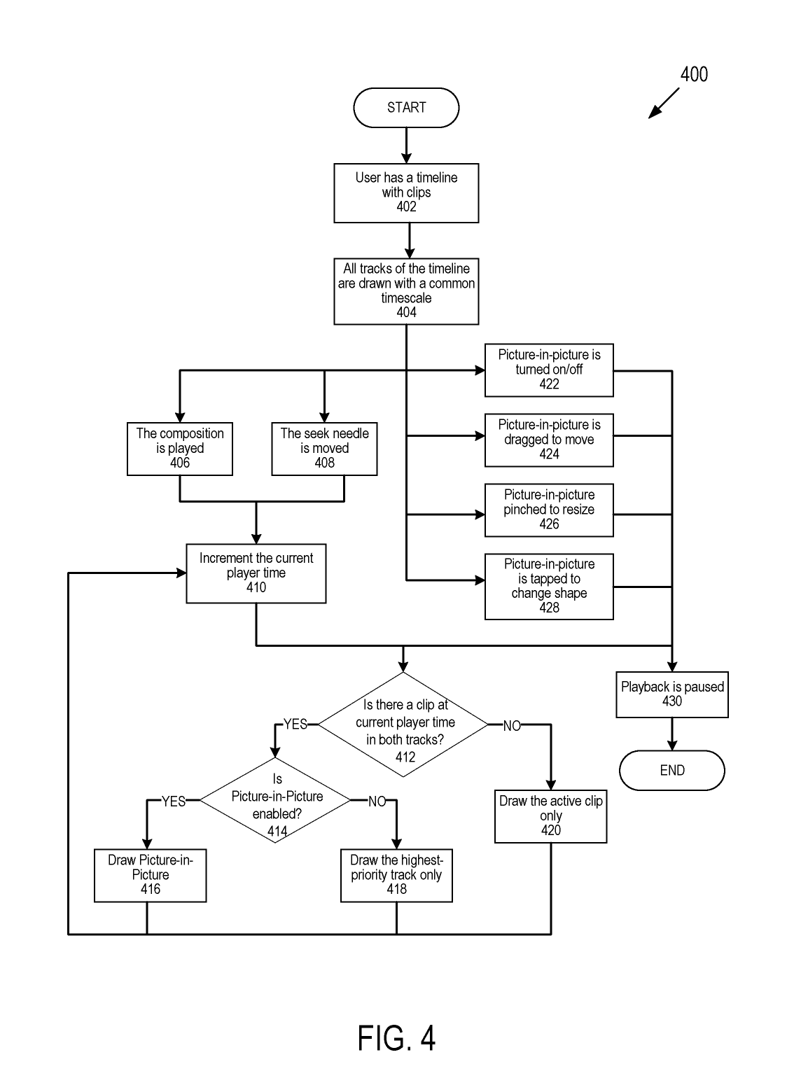

The multi-track edit engine 130 may facilitate multi-track editing processes. In an implementation, the multi-track edit engine 130 may access one or more processors of the mobile video editing system 104 and may access memory on the mobile video editing system 104 configured to instruct the one or more processors to perform the computer-implemented method shown in FIG. 4.

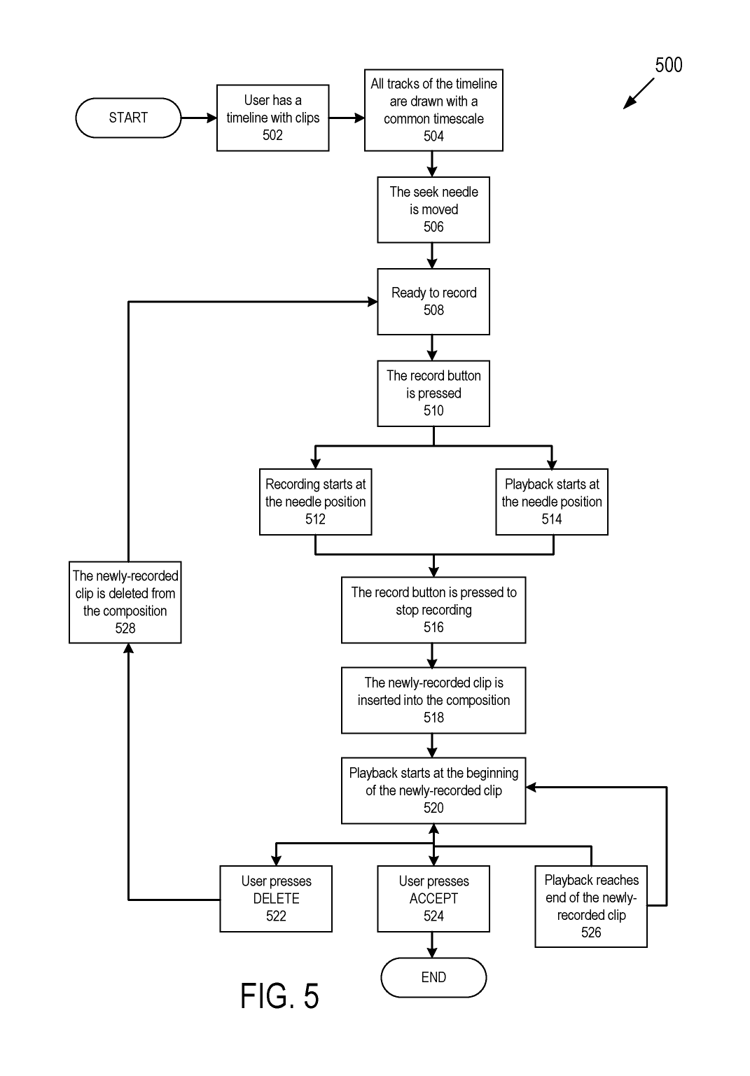

The voiceover management engine 132 may facilitate voiceover processes. In an implementation, the voiceover management engine 132 may access one or more processors of the mobile video editing system 104 and may access memory on the mobile video editing system 104 configured to instruct the one or more processors to perform the computer-implemented method shown in FIG. 5.

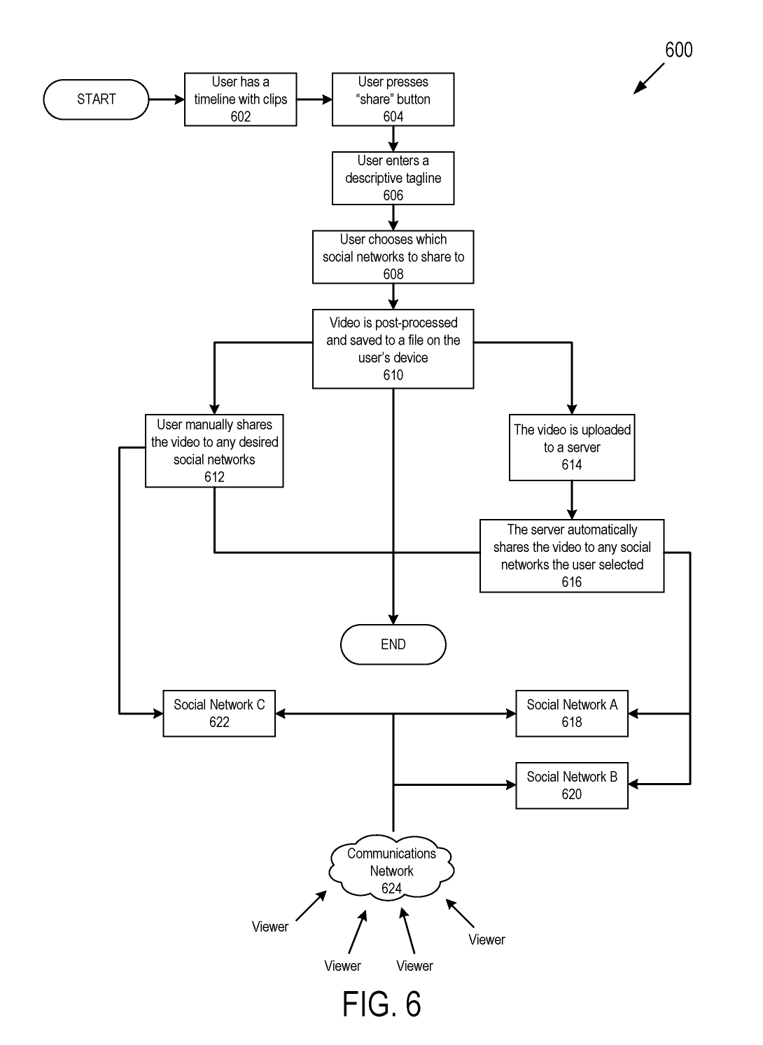

The video sharing/publication interface engine 134 may facilitate content sharing and/or publication. In an implementation, the video sharing/publication interface engine 134 may access one or more processors of the mobile video editing system 104 and may access memory on the mobile video editing system 104 configured to instruct the one or more processors to perform the computer-implemented method shown in FIG. 6.

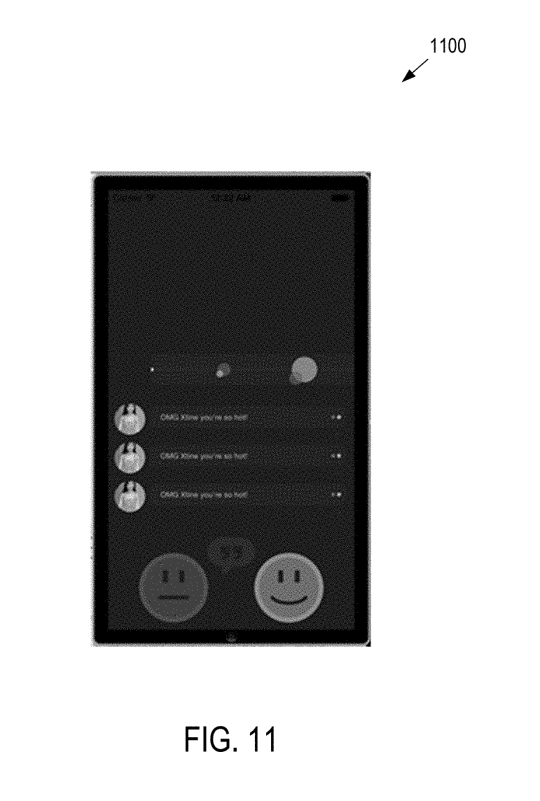

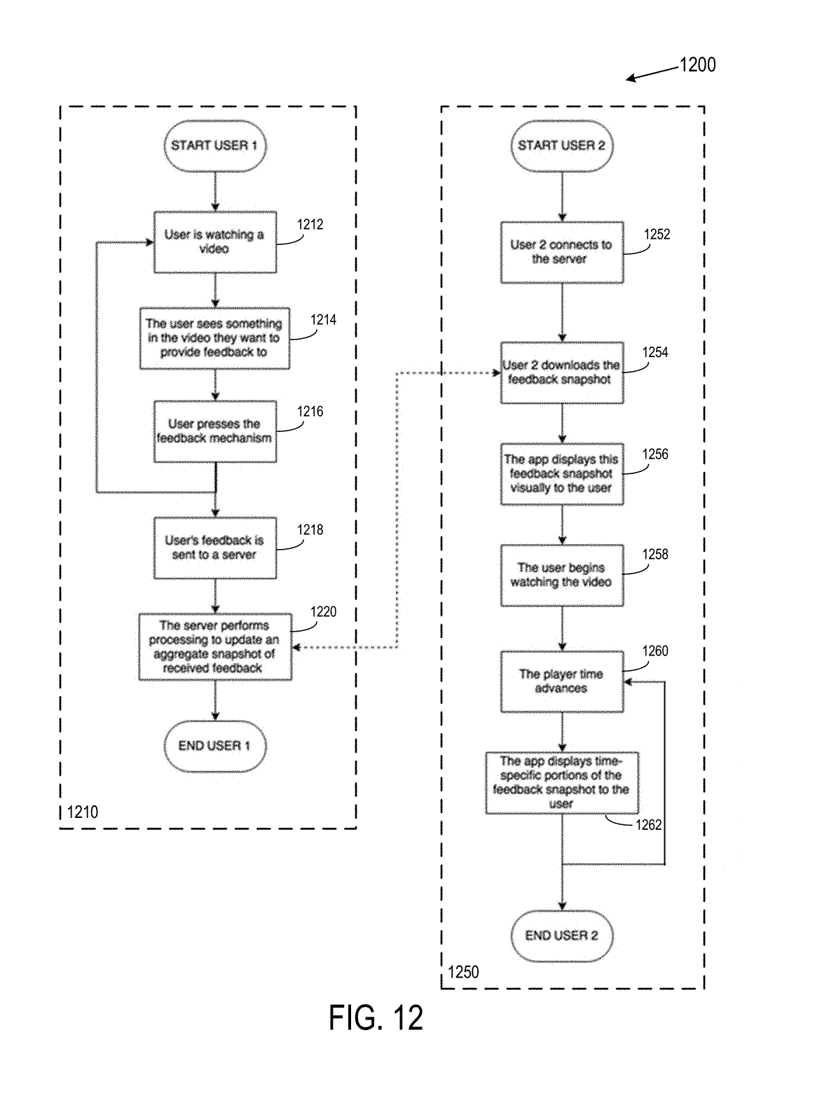

The touch feedback engine 136 may facilitate touch feedback. The touch feedback features referenced herein may be shown further in FIG. 11. The touch feedback engine 136 may operate to allow viewers to interact with the screen while watching a video. Interactions from all viewers may be captured along with the time in the video at which they occurred. Examples of interactions are: like, dislike, mood, tagging of people, content, or semantic meaning, presence of copyrighted content. Interactions from all users may be combined and displayed as a visual “interest graph” which informs viewers on the most compelling portions of time in the video. In some implementations, viewers, especially teenagers, may have a limited attention span for videos longer than 6 seconds. A visual “interest graph” may let users know what's coming ahead in the video, so they relax or skip ahead. Viewers can be bored during longer videos, so giving them something to touch/play with during the video makes their overall experience more entertaining. This may give viewers a participatory role in a content community is important, because they often feel left out if they are not video creators. The touch feedback engine 136 may advantageously allow content creators to make longer videos on mobile because viewers will now watch them. The touch feedback engine 136 may support higher engagement for viewers. The touch feedback engine 136 may implement the computer-implemented method shown in FIG. 12.

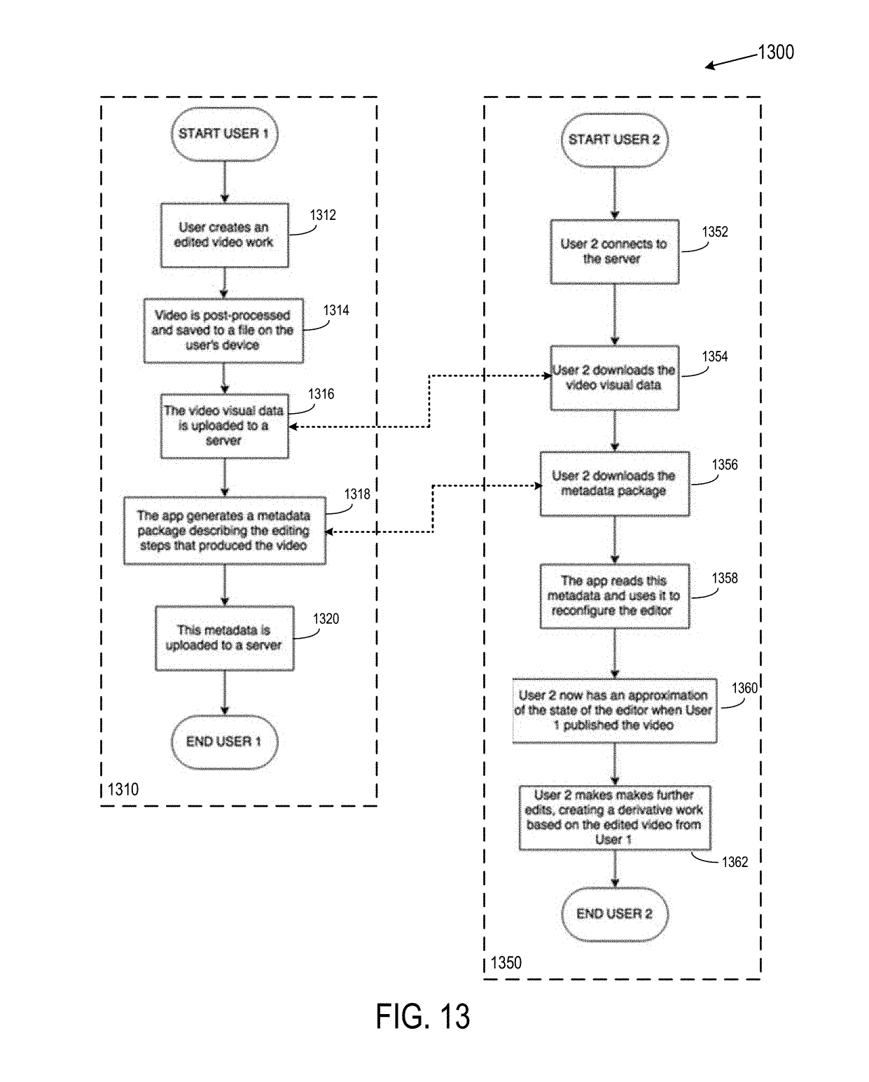

The re-editable mobile video engine 138 may facilitate re-editable mobile video. The re-editable mobile video engine 138 may operate to solve the problem that users often want to re-edit videos after publishing but are unable to do so without deleting and re-publishing the video. That is, users often delete the component footage from published videos, so they are unable to edit the component parts. Further, users often want to use a portion of a previous video in a new video, but not the whole video. These situations require a lot of work for a user to manually deconstruct a video into its component parts, and it would be impossible for most editing operations beyond splitting the clip into smaller pieces. Additionally, for creators, the video feels final. This inhibits creativity, and makes it less likely that people will create video versus text. The re-editable mobile video engine 138 may allow users to experiment with content, and encourages them to edit it later and/or recycle content. The re-editable mobile video engine 138 may provide re-editable mobile video services. More specifically, in some implementations, the second user may edit a video using a video editing application supported by the mobile video editing system 104. The video editing application may save editing meta-data when the first user creates the video in its editor. Users (e.g., the second user) can download the video from the mobile video editing system 104 after they have published the video. The mobile video editing system 104 may re-create the video's component parts for re-editing in its editor. The re-editable mobile video engine 138 may implement the computer-implemented method shown in FIG. 13.

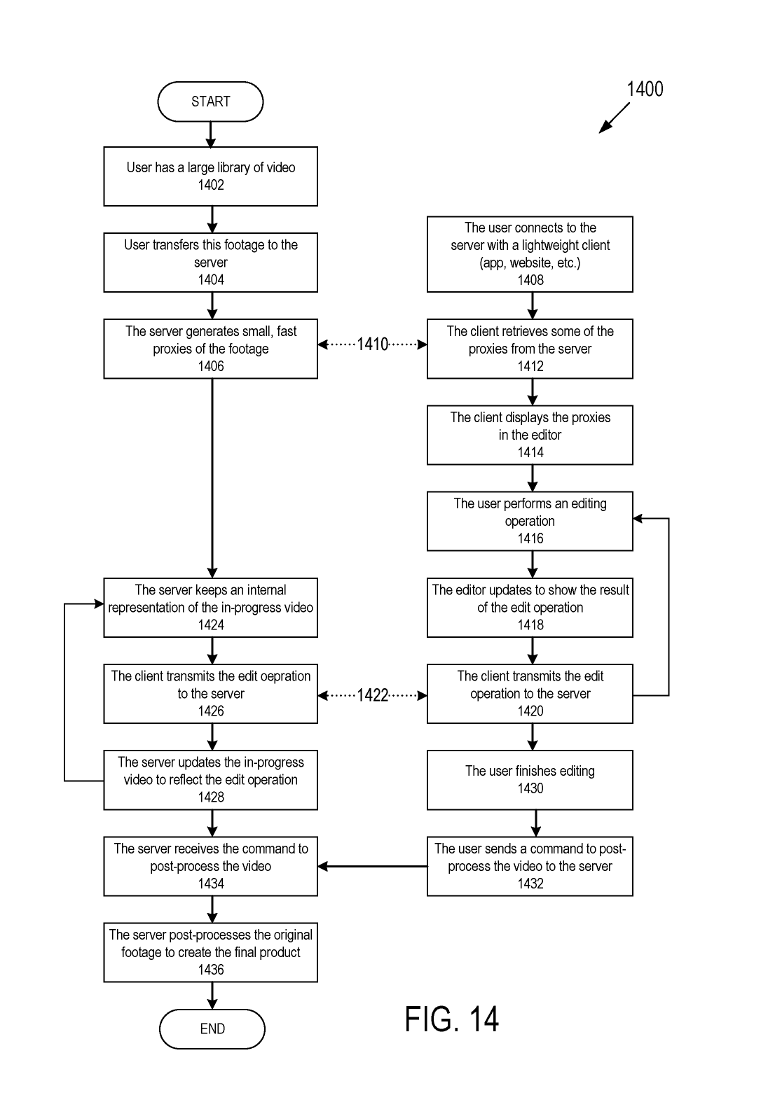

The proxy editing engine 140 may facilitate proxy video editing. The proxy editing engine 140 may operate to provide remote-controlled/“proxy” editing services. For instance, a user may have video footage, perhaps at high resolution or a large archive of footage. This footage may be too big or there is too much of it to effectively store on a video interaction system 112 of the user. The footage may be uploaded to the mobile video editing system 104, either from the video interaction system 112 itself or from another device (desktop computer, network-attached storage, another server) attached to the video interaction system 112. The mobile video editing system 104 may prepare low resolution “proxies” of the videos that have been uploaded. These proxies may be downloaded to the video interaction system 112. The user may edit the proxy representations of the clips, editing, trimming and combining them. The video interaction system 112 may transmit a stream of these changes back to the mobile video editing system 104 and the changes may be performed there on the full-resolution footage. In this way the user may be able to edit footage too large to process on a mobile device using a familiar mobile video editing interface. Advantages include the ability to edit footage that would not otherwise fit on phones. Users can use intuitive editor software to edit footage that would conventionally require a trained operator and a sophisticated desktop editing suite. The proxy editing engine 140 may implement the computer-implemented method shown in FIG. 14.

The video editing management system 106 may include one or more engines and/or datastores to support the video editing engine. The video editing management system 106 may support the edit access engine 126, the single-track edit engine 128, the multi-track edit engine 130, the voiceover management engine 132, and/or the video sharing/publication interface engine 134. The video sharing/publication system 108 may facilitate sharing or publication of content created on the mobile video editing system 104. The video sharing/publication system 108 may, more particularly, support the video sharing/publication engine 122. The social media system 110 may support social media and/or social networking. In various implementations, the social media system 110 supports a social media and/or a social networking application on the mobile video editing system 104. The video interaction system(s) 112 may include one or more digital devices configured to view content created on the mobile video editing system 104. The video interaction system(s) 112 may include a first video interaction system 112-1 through an Nth video interaction system 112-N. The video interaction system(s) 112 may include one or more of a mobile phone, a tablet computing device, an IoT device, a laptop computer, and a desktop computer.

FIG. 2 shows an example of a flowchart of a method 200 for accessing mobile multi-track timeline optimized editing processes on a mobile device, according to some implementations. The method 200 may be managed, performed, etc. by the edit access engine 126. It is noted the operations in the method 200 are by way of example only, and that various implementations may have more or less operations than those explicitly shown.

At an operation 202, video footage may be captured. At an operation 204, footage may be saved. At an operation 206, the clip may be automatically appended to the end of a timeline. At an operation 208, the application may import all footage from the user's phone. At an operation 210, the application may display a list of clips to the user. At an operation 212, the user may drag a clip from the tray into the timeline. At an operation 214, the user may have a timeline with the clips. At an operation 216, the timeline may be drawn to scale.

FIG. 3 shows an example of a flowchart of a method 300 for performing a single-track editing process on a mobile device, according to some implementations. The method 300 may be managed, performed, etc. by the single-track edit engine 128. It is noted the operations in the method 300 are by way of example only, and that various implementations may have more or less operations than those explicitly shown.

At an operation 302, the user may have a timeline with clips. At an operation 304, the timeline may be drawn to scale. At an operation 306, a clip may be moved from one position to another. At an operation 308, a clip may be duplicated. At an operation 310, a clip may be removed. At an operation 312, a clip may be trimmed. At an operation 314, a clip may be zoomed. At an operation 316, a clip may be cropped. At an operation 318, the composition may be played. At an operation 320, the composition may be paused. At an operation 324, the seek needle may be moved. At an operation 326, the player may seek to a new time.

FIG. 4 shows an example of a flowchart of a method 400 for performing a multi-track editing process on a mobile device, according to some implementations. The method 400 may be managed, performed, etc. by the multi-track edit engine 130. It is noted the operations in the method 400 are by way of example only, and that various implementations may have more or less operations than those explicitly shown.

At an operation 402, a user may have a timeline with clips. At an operation 404, all tracks of the timeline may be drawn with a common timescale. At an operation 406, the composition may be played. At an operation 408, the seek needle may be removed. At an operation 410, the current player time may be incremented. At a decision point 412, it is determined if there is a clip at the current player time in both tracks. At a decision point 414, it is determined whether picture-in-picture is enabled. At an operation 416, picture-in-picture is drawn. At an operation 418, the highest-priority track only is drawn. At an operation 420, the active clip only is drawn. At an operation 422, the picture-in-picture is turned on/off. At an operation 424, the picture-in-picture is dragged to move. At an operation 426, the picture-in-picture is pinched to resize. At an operation 428, the picture-in-picture is tapped to change shape. At an operation 430, playback is paused.

FIG. 5 shows an example of a flowchart of a method 500 for performing voiceover recording over a video on a mobile device, according to some implementations. The method 500 may be managed, performed, etc. by the voiceover management engine 132. It is noted the operations in the method 500 are by way of example only, and that various implementations may have more or less operations than those explicitly shown.

At an operation 502, the user may have a timeline with clips. At an operation 504, all tracks of the timeline are drawn with a common timescale. At an operation 506, the seek needle may be moved. At an operation 508, the system is ready to record. At an operation 510, the record button may be pressed. At an operation 512, the recording needle may start at the needle position. At an operation 514, the playback may start at the needle position. At an operation 516, the record button may be pressed to stop recording. At an operation 518, the newly-recorded clip may be inserted into the composition. At an operation 520, the playback may start at the beginning of the newly recorded clip. At an operation 522, the user may press delete. At an operation 524, the user may press accept. At an operation 526, the playback may reach the end of the newly recorded clip. At an operation 528, the newly-recorded may be deleted from the composition.

FIG. 6 shows an example of a flowchart of a method 600 for sharing/publishing content created on a mobile device, according to some implementations. The method 600 may be managed, performed, etc. by the voiceover management engine 132. It is noted the operations in the method 600 are by way of example only, and that various implementations may have more or less operations than those explicitly shown.

At an operation 602, the user may have a timeline with clips. At an operation 604, the user may press a “share” button in an application. At an operation 606, the user may enter a descriptive tagline. At an operation 608, the user may choose a social network to share. At an operation 610, the video may be post-processed and saved to a file on the user's device. At an operation 612, the user may manually share the video to a social network. At an operation 614, the video may be uploaded to a server. At an operation 616, the server may automatically share the video to a social network selected by the user. At operation 618, 620, and 622, the video is shared to social networks A, B, and C. At an operation 624, viewers access the video on social networks A, B, and C.

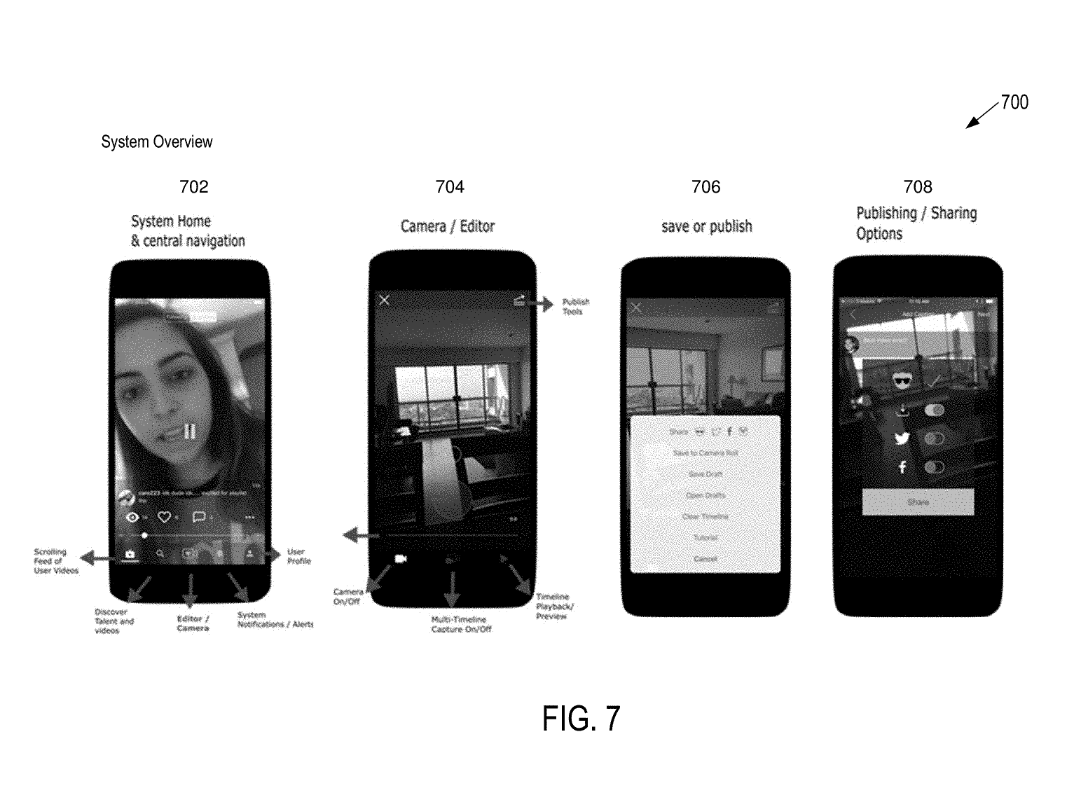

FIG. 7 shows an example of screen captures 700 taken on a mobile device having an application implementing mobile multi-track timeline optimized editing processes, according to some implementations. The screen captures 700 may include a first screen capture 702 of a system home and central navigation. The first screen capture 702 may include user interface elements for scrolling a feed of user videos, discovering talent and videos, accessing the editor and/or the camera, receiving system notifications and/or alerts, and accessing a user profile. A second screen capture 704 may show the camera/editor and may include user interface elements for accessing publishing tools, for turning the camera on or off, for turning multi-track timeline capture on or off, and for allowing timeline playback/review. A third screen capture 706 may show save or publish options including options to share, save, save drafts, open drafts, clear timelines, a tutorial and cancel. A fourth screen capture 708 may show publishing/sharing options on, e.g., various social networks.

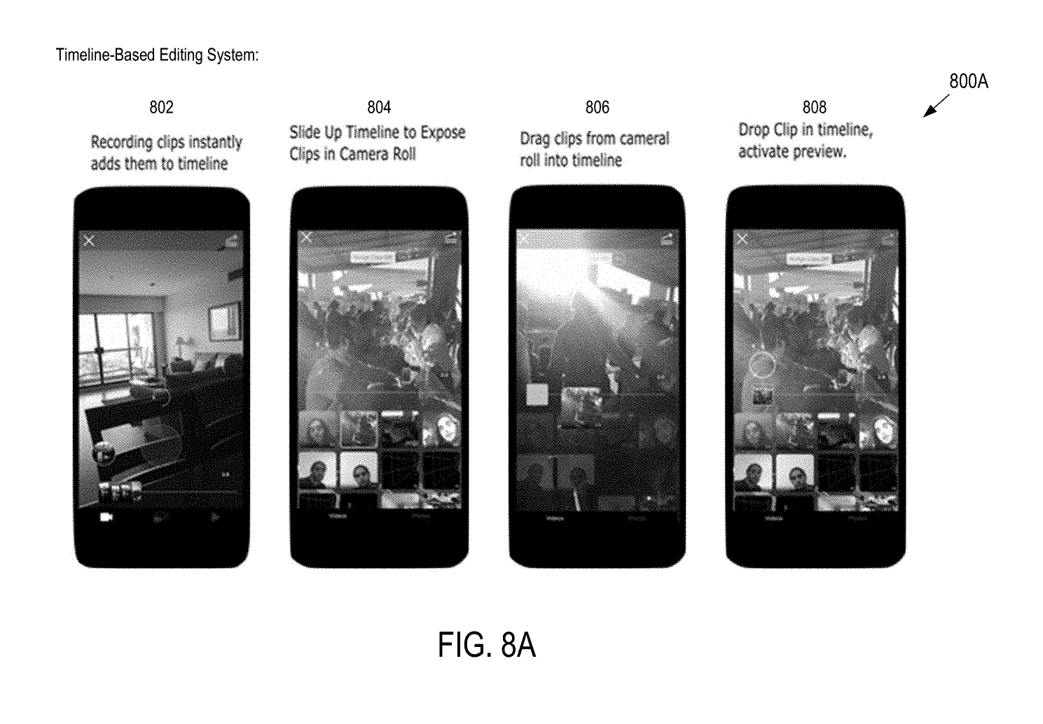

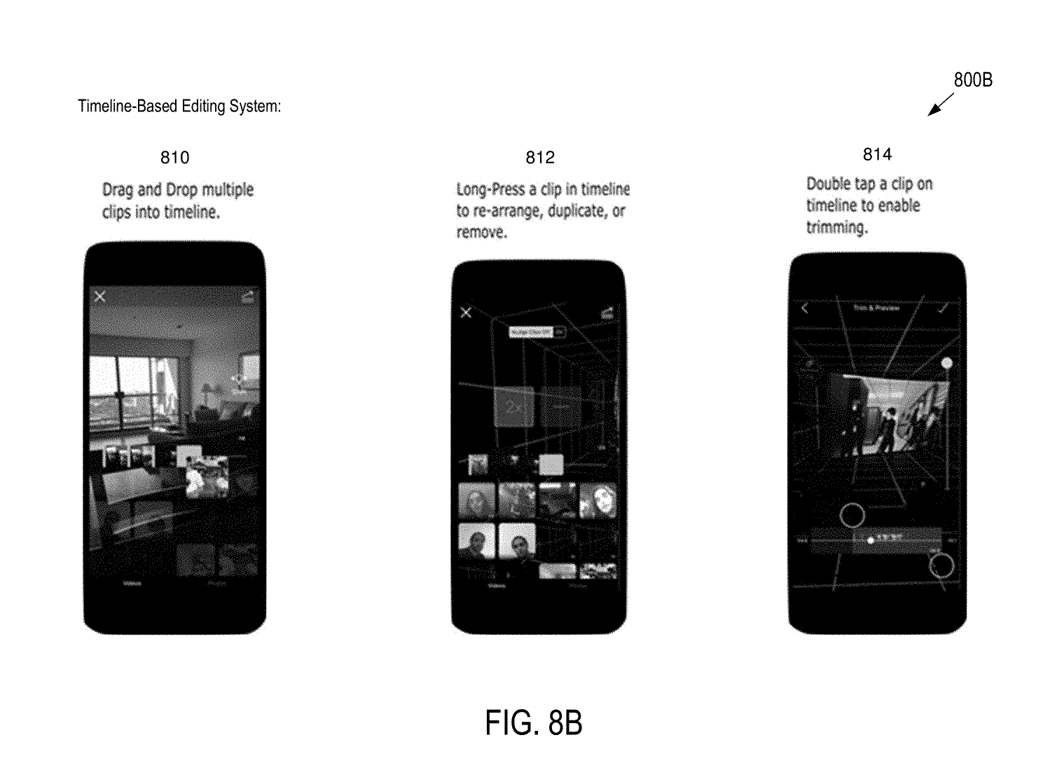

FIG. 8A and FIG. 8B show examples of screen captures 800A and 800B taken on a mobile device having an application implementing mobile multi-track timeline optimized editing processes, according to some implementations. A first screen capture 802 may show how recording clips adds them directly to a timeline. A second screen capture 804 may show how sliding up a timeline may expose clips in the camera roll. A third screen capture 806 may show how dragging clips from the camera roll can place the clips in the timeline. A fourth screen capture 808 may show how dropping clips in the timeline may activate preview. A fifth screen capture 810 may show how dragging and dropping multiple clips into a timeline may occur. A sixth screen capture 812 may show how long-pressing a clip in a timeline may re-arrange, duplicate, or remove the clip. A seventh screen capture 814 may show how double tapping a clip on the timeline may enable trimming of the clip.

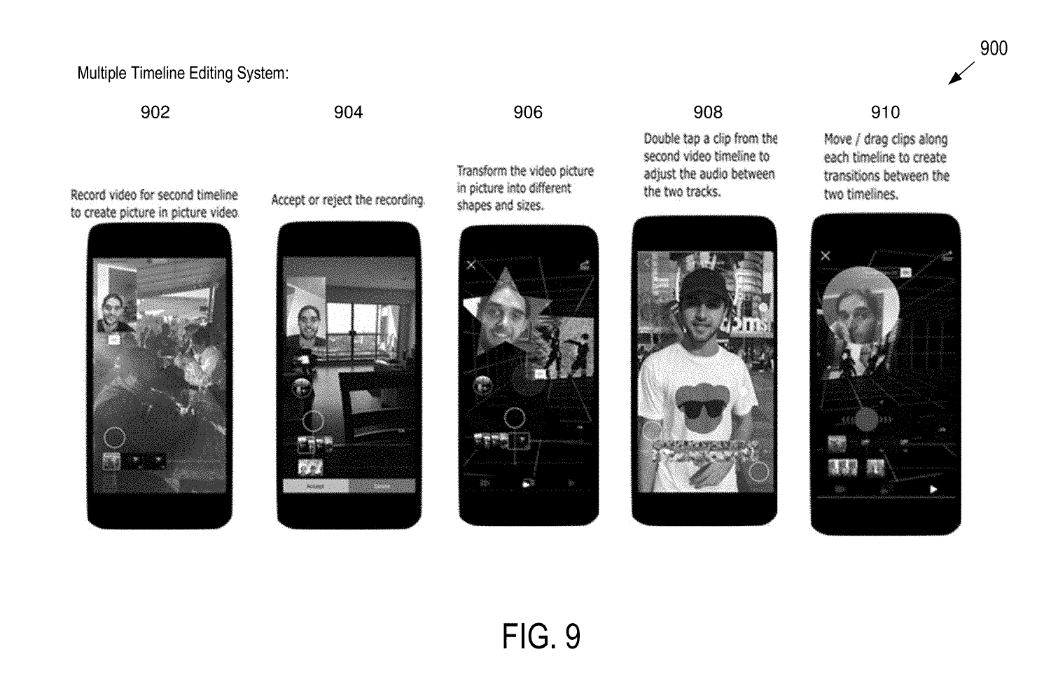

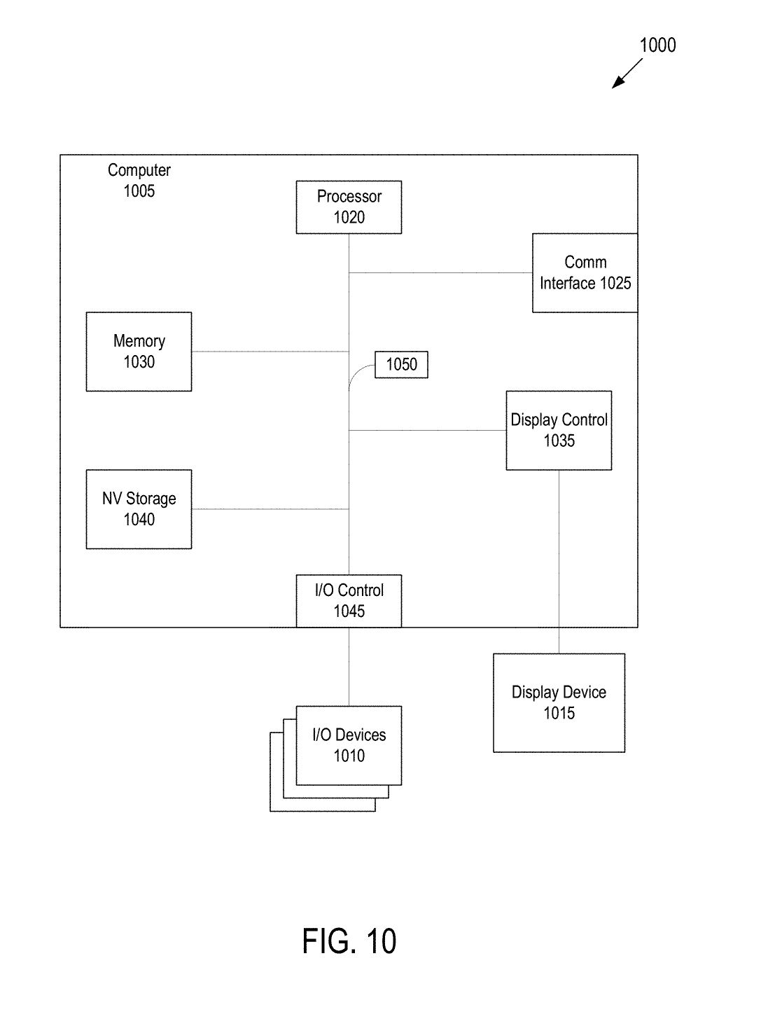

FIG. 9 shows an example of screen captures 900 taken on a mobile device having an application implementing mobile multi-track timeline optimized editing processes, according to some implementations. A first screen capture 902 may show how to record video for a second timeline to create a picture-in-picture video. A second screen capture 904 may show options to accept or reject the recording. A third screen capture 906 may show options to transform the video-in-picture into different shapes and sizes. A fourth screen capture 908 may show options to double tap a clip from a second timeline to adjust the audio between the two tracks. A fifth screen capture 910 may show options to move/drag clips along each timeline to create transitions between the two timelines. FIG. 10 shows an example of a computer system 1000. In the example of FIG. 10, the digital device 1000 can be a conventional computer system that can be used as a client computer system, such as a wireless client or a workstation, or a server computer system. The digital device 1000 includes a computer 1005, I/O devices 1010, and a display device 1015. The computer 1005 includes a processor 1020, a communications interface 1025, memory 1030, display controller 1035, non-volatile storage 1040, and I/O controller 1045. The computer 1005 can be coupled to or include the I/O devices 1010 and display device 1015.

The computer 1005 interfaces to external systems through the communications interface 1025, which can include a modem or network interface. It will be appreciated that the communications interface 1025 can be considered to be part of the digital device 1000 or a part of the computer 1005. The communications interface 1025 can be an analog modem, ISDN modem, cable modem, token ring interface, satellite transmission interface (e.g. “direct PC”), or other interfaces for coupling a computer system to other computer systems.

The processor 1020 can be, for example, a conventional microprocessor such as an Intel Pentium microprocessor or Motorola power PC microprocessor. The memory 1030 is coupled to the processor 1020 by a bus 1050. The memory 1030 can be Dynamic Random Access Memory (DRAM) and can also include Static RAM (SRAM). The bus 1050 couples the processor 1020 to the memory 1030, also to the non-volatile storage 1040, to the display controller 1035, and to the I/O controller 1045.

The I/O devices 1010 can include a keyboard, disk drives, printers, a scanner, and other input and output devices, including a mouse or other pointing device. The display controller 1035 can control in the conventional manner a display on the display device 1015, which can be, for example, a cathode ray tube (CRT) or liquid crystal display (LCD). The display controller 1035 and the I/O controller 1045 can be implemented with conventional well known technology.

The non-volatile storage 1040 is often a magnetic hard disk, an optical disk, or another form of storage for large amounts of data. Some of this data is often written, by a direct memory access process, into memory 1030 during execution of software in the computer 1005. One of skill in the art will immediately recognize that the terms “machine-readable medium” or “computer-readable medium” includes any type of storage device that is accessible by the processor 1020 and also encompasses a carrier wave that encodes a data signal.

The digital device 1000 is one example of many possible computer systems which have different architectures. For example, personal computers based on an Intel microprocessor often have multiple buses, one of which can be an I/O bus for the peripherals and one that directly connects the processor 1020 and the memory 1030 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1030 for execution by the processor 1020. A Web TV system, which is known in the art, is also considered to be a computer system, but it can lack some of the features shown in FIG. 10, such as certain input or output devices. A typical computer system will usually include at least a processor, memory, and a bus coupling the memory to the processor.

FIG. 11 shows an example of a screen capture 1100 taken on a mobile device having an application implementing touch feedback design, according to some implementations. The black space at the top is for a video. The red dots under the video indicate clusters of positive feedback (green dots) and clusters of negative feedback (red dots) from the community of viewers. This graph has units of time in the horizontal axis, and units of magnitude indicated by the size of the dots. However this is just an example, any units of measure to indicate interest and relevancy to a portion of the video could be used. The red and green faces at the bottom are touch feedback triggers. Our current designs would feature invisible touch triggers over a full screen video.

FIG. 12 shows an example of a flowchart of a method 1200 for performing a touch feedback video editing process on a mobile device, according to some implementations. In some implementations, the method 1200 may be performed by instructions provided by the touch feedback engine 136. The method 1200 may include a first method 1210 executed on a first mobile device and a second method 1250 executed on a second mobile device. Each of the first mobile device and the second mobile device may correspond to a video interaction system 112, as noted herein.

At an operation 1212, a first user may be watching a video. At an operation 1214, the first user may see something in the video that they want to provide feedback to. At an operation 1216, the first user may press a feedback mechanism. At an operation 1218, the first user's feedback may be sent to the mobile video editing system 104. At an operation 1220, the mobile video editing system 104 may perform processing to update an aggregate snapshot (e.g., a visual feedback representation) of the received feedback.

At an operation 1252, the second user may connect to the mobile video editing system 104. At an operation 1254, the second user may download the aggregate snapshot of the received feedback. At an operation 1256, the second mobile device may display the feedback snapshot visually to the second user (e.g., as a visual interest graph). At an operation 1258, the second user may begin watching the video. At an operation 1260, the second player may advance time in the video. At an operation 1262, the application in the second user device may display time-specific portions of the aggregated snapshot of the received feedback to the second user.

FIG. 13 shows an example of a flowchart of a method 1300 for performing a re-editable mobile video system process on a mobile device, according to some implementations. In some implementations, the method 1300 may be performed by instructions provided by the re-editable mobile video engine 138. The method 1300 may include a first method 1310 executed on a first mobile device and a second method 1350 executed on a second mobile device. Each of the first mobile device and the second mobile device may correspond to a video interaction system 112, as noted herein.

At an operation 1312, a first user may create an edited video work. At an operation 1314, the video may be post-processed and saved to a file on the first user device. At an operation 1316, the video visual data may be uploaded to the mobile video editing system 104. At an operation 1318, the application on the first mobile device may generate a metadata package describing the editing steps that produced the video. At an operation 1320, the metadata may be uploaded to the mobile video editing system 104.

At an operation 1352, the second mobile device may connect to the mobile video editing system 104. At an operation 1354, the second mobile device may download the video visual data. At an operation 1356, the second mobile device may download the metadata package. At an operation 1358, an application on the second mobile device may read the metadata and use it to reconfigure an editor. At an operation 1360, the second mobile device may now have an approximation of the state of the editor when the first mobile device published the video. At an operation 1362, the second user on the second mobile device may make further edits, creating a derivative work that is based on the edited video from the first user on the first mobile device.

FIG. 14 shows an example of a flowchart of a method 1400 for performing a proxy editing process on a mobile device, according to some implementations. In some implementations, the method 1400 may be performed by instructions provided by the proxy editing engine 140.

At an operation 1402, a user has a large library of videos. At an operation 1404, the user transfers the videos to the video datastore 124 of the mobile video editing system 104. At an operation 1406, the proxy editing engine 140 generates small, fast proxies of the videos. At an operation 1408, a user of a video interaction system 112 may connect to the mobile video editing system 104 with a lightweight client (e.g., an application, a website, etc.). At an operation 1410, the mobile video editing system 104 may transfer the proxies to the video interaction system 112.

At an operation 1412, the video interaction system 112 may receive some of the proxies from the mobile video editing system 104. At an operation 1414, the video interaction system 112 may display the proxies in the editor. At an operation 1416, the user of the video interaction system 112 may perform an editing operation. At an operation 1418, the editor may update to show the result of the edit operation. At an operation 1420, the video interaction system 112 may transmit (operation 1422) the edit operation to the mobile video editing system 104. At an operation 1424, the proxy editing engine 140 may keep an internal representation of the in-progress video. At an operation 1426, the proxy editing engine 140 may receive the edit operation. At an operation 1428, the proxy editing engine 140 may update the in-progress video to reflect the edit operation. At an operation 1430, the user of the video interaction system 112 may finish editing. At an operation 1432, the user may send a command to post-process the video to the proxy editing engine 140. At an operation 1434, the proxy editing engine 140 may receive the command to post-process the video. At an operation 1436, the proxy editing engine 140 may post-process the original video footage to create the final product.

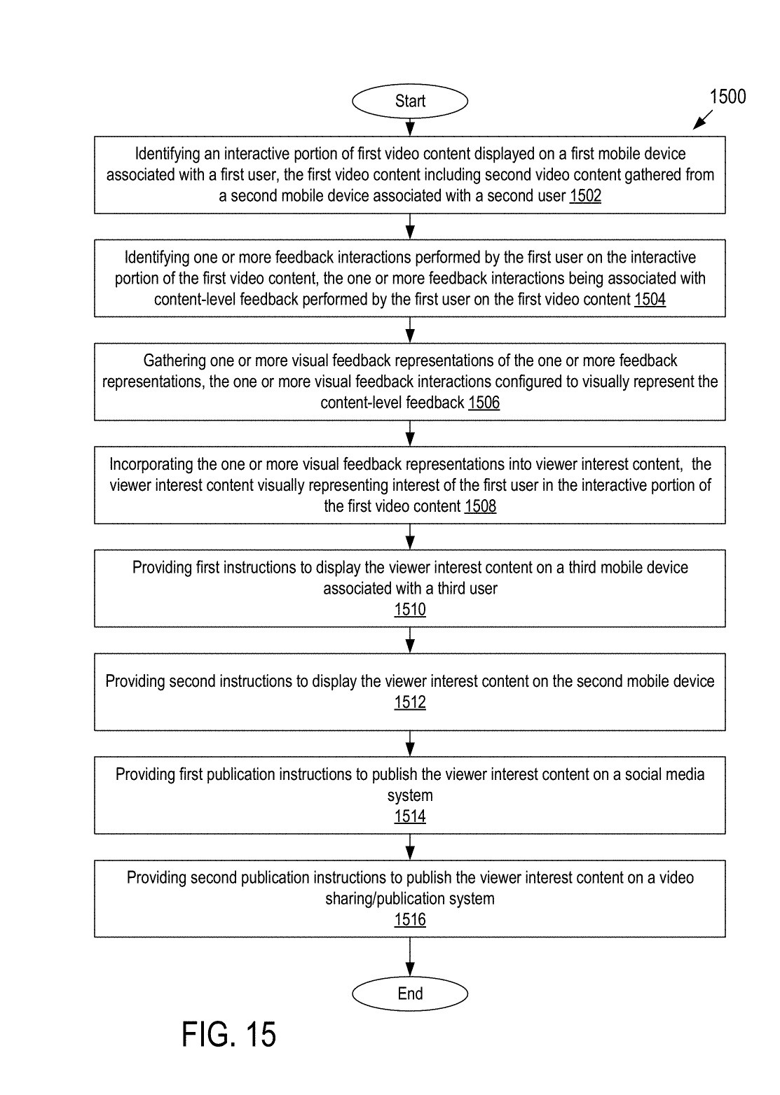

FIG. 15 shows an example of a flowchart of a method 1500 for displaying viewer interest content for video content, according to some implementations. The method 1500 may be executed by the touch feedback engine 136 and/or other modules of the mobile video editing system 104. It is noted the operations in the method 1500 are by way of example only, and that various implementations may have more or less operations than those explicitly shown.

At an operation 1502, an interactive portion of first video content displayed on a first mobile device associated with a first user may be identified. The first video content may include second video content gathered from a second mobile device associated with a second user. An “interactive portion,” as used herein, may comprise any portion of video content configured to receive user input from a viewer. Interactive portions may include specific times in video content that a user can provide annotations, gestures, voice input, etc. Interactive portions may include portions of a timeline that a user can interact with. In some implementations, interactive portions include portions of video content that can receive edits. In some implementations, the first video content and the second video content may be substantially time-synchronized, e.g., may have similar content at start points, end points, and/or intermediate points. In some implementations, the first video content and the second video content may be streamed from video interaction system(s) 112.

At an operation 1504, one or more feedback interactions performed by the first user on the interactive portion of the first video content may be identified. The one or more feedback interactions may be associated with content-level feedback performed by the first user on the first video content. A “feedback interaction,” as used herein, may include any user interaction that provides feedback about content (e.g., content-level feedback) to another user. Feedback interactions may include, without limitation, positive sentiment feedback interactions (e.g., likes), negative sentiment feedback interactions (e.g., dislikes), mood interactions (showings of love, sadness, anger, etc.), user tagging interactions (e.g., associating another user with an interactive portion), semantic meaning interactions (e.g., providing written and/or other explanations for an interactive portion), copyright notice interactions (e.g., providing notice that video content infringes a copyright or other intellectual property), etc.

At an operation 1506, one or more visual feedback representations of the one or more feedback representations may be gathered. The one or more visual feedback interactions configured to visually represent the content-level feedback. In some implementations, the virtual feedback representations comprise annotations, icons, etc. that provide visual depictions of the feedback representations.

At an operation 1508, the one or more visual feedback representations may be incorporated into viewer interest content. The viewer interest content may visually represent interest of the first user in the interactive portion of the first video content. “Viewer interest content,” as used herein, may include any content configured to represent interest of user(s) in interactive portions of video content. Viewer interest content may include a visual interest graph of aggregated feedback from a plurality of users of the video interaction system(s) 112. In some implementations, the visual interest graph comprises a visual depiction of popularity of interactive portion(s) of the first video content. The visual interest graph may further comprise a visual depiction of one or more of the most popular portions of the first video content. As an example, the visual interest graph may comprise a depiction of specific time(s), specific objects, specific people, specific subjects, etc. that are popular relative to similarly situated items. In some implementations, the visual interest graph comprises a visual depiction of time-specific portions of a visual depiction of one or more most popular portions of the first video content.

At an operation 1510, first instructions to display the viewer interest content on a third mobile device associated with a third user may be provided. The first instructions may configure a video interaction system 112 to display the viewer interest content. As noted herein, the viewer interest content may comprise a visual interest graph of aggregated feedback from a plurality of users of the video interaction system(s) 112. The viewer interest content may be configured to be displayed in a mobile application executing on the video interaction system(s) 112. At an operation 1512, second instructions to display the viewer interest content on the second mobile device may be provided. More specifically, the viewer interest content may be displayed on a second of the video interaction system(s) 112 and/or other devices. At an operation 1514, first publication instructions to publish the viewer interest content on a social media system may be provided. At an operation 1516, second publication instructions to publish the viewer interest content on a video sharing/publication system may be provided.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “some implementations”, “various implementations”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some implementations, but also variously omitted in other embodiments. Similarly, various features are described that may be preferences or requirements for some implementations, but not other embodiments.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the embodiments is intended to be illustrative, but not limiting, of the scope, which is set forth in the claims recited herein.

We claim:

1. A computer-implemented method comprising:
identifying an interactive portion of first video content displayed on a first mobile device associated with a first user, the first video content including second video content gathered from a second mobile device associated with a second user;
identifying one or more feedback interactions performed by the first user on the interactive portion of the first video content, the one or more feedback interactions being associated with content-level feedback performed by the first user on the first video content;
gathering one or more visual feedback representations of the one or more feedback representations, the one or more visual feedback interactions configured to visually represent the content-level feedback;
incorporating the one or more visual feedback representations into viewer interest content, the viewer interest content visually representing interest of the first user in the interactive portion of the first video content; and
providing first instructions to display the viewer interest content on a third mobile device associated with a third user.

2. The computer-implemented method of claim 1, wherein the viewer interest content comprises a visual interest graph of aggregated feedback from a plurality of users about the interactive portion of the first video content.

3. The computer-implemented method of claim 2, wherein the visual interest graph comprises a visual depiction of popularity of the interactive portion of the first video content.

4. The computer-implemented method of claim 2, wherein the visual interest graph comprises a visual depiction of one or more most popular portions of the first video content.

5. The computer-implemented method of claim 2, wherein the visual interest graph comprises a visual depiction of time-specific portions of a visual depiction of one or more most popular portions of the first video content.

6. The computer-implemented method of claim 1, wherein the one or more feedback interactions comprise one or more of: a positive sentiment feedback interaction, a negative sentiment feedback interaction, a mood interaction, a user tagging interaction, a semantic meaning interaction and a copyright notice interaction.

7. The computer-implemented method of claim 1, wherein the first video content and the second video content are substantially time-synchronized with one another.

8. The computer-implemented method of claim 1, wherein the first video content is streamed to the first user device, and the second video content is streamed from the second user device.

9. The computer-implemented method of claim 8, wherein the first video content streamed to the first user device over a first wireless connection, and the second video content is streamed from the second user device over a second wireless connection.

10. The computer-implemented method of claim 1, further comprising providing second instructions to display the viewer interest content on the second mobile device.

11. The computer-implemented method of claim 10, wherein the viewer interest content is incorporated into a depiction of the second video content.

12. The computer-implemented method of claim 1, further comprising providing first publication instructions to publish the viewer interest content on a social media system.

13. The computer-implemented method of claim 1, further comprising providing second publication instructions to publish the viewer interest content on a video sharing/publication system.

14. The computer-implemented method of claim 1, wherein the first mobile device, the second mobile device, or the third mobile device comprises a mobile phone.

15. A system comprising:
one or more processors;
memory coupled to the one or more processors, the memory configured to store computer program instructions that instruct the one or more processors to perform a computer-implemented method comprising:
identifying an interactive portion of first video content displayed on a first mobile device associated with a first user, the first video content including second video content gathered from a second mobile device associated with a second user;
identifying one or more feedback interactions performed by the first user on the interactive portion of the first video content, the one or more feedback interactions being associated with content-level feedback performed by the first user on the first video content;
gathering one or more visual feedback representations of the one or more feedback representations, the one or more visual feedback interactions configured to visually represent the content-level feedback;
incorporating the one or more visual feedback representations into viewer interest content, the viewer interest content visually representing interest of the first user in the interactive portion of the first video content; and
providing first instructions to display the viewer interest content on a third mobile device associated with a third user.

16. The system of claim 15, wherein the viewer interest content comprises a visual interest graph of aggregated feedback from a plurality of users about the interactive portion of the first video content.

17. The system of claim 16, wherein the visual interest graph comprises a visual depiction of popularity of the interactive portion of the first video content.

18. The system of claim 16, wherein the visual interest graph comprises a visual depiction of one or more most popular portions of the first video content.

19. The system of claim 16, wherein the visual interest graph comprises a visual depiction of time-specific portions of a visual depiction of one or more most popular portions of the first video content.
